(19) United States
(12) Patent Application Publication
(10) Pub. No.: US 2003/0090368 A1
(43) Pub. Date: May 15, 2003

(54) Device and method for converting a two-directional so data stream for transmission via a low-voltage power network

(76) Inventors: Hans-Dieter Ide, Dortmund (DE); Ralf Neuhaus, Lunen (DE); Joerg Stolle, Mulheim (DE)

Correspondence Address: BELL, BOYD & LLOYD, LLC, P. O. BOX 1135, CHICAGO, IL, 60690-1135, US

(21) Appl. No.: 10/169,291

(22) PCT Filed: Dec. 19, 2000
(86) PCT No.: PCT/DE00/04541

(30) Foreign Application Priority Data
Dec. 30, 1999 (DE) 199 63 816.0

(51) Int. Cl. H04M 11/04

(52) U.S. Cl. 340/310.06

(57) ABSTRACT

The pseudoternary data stream is comprised of a sequence of S_{O} frames (SR) and is converted into a binary data stream consisting of a sequence of binary frames (BR). First transmission packets provided for transmission of data in a first direction of transmission (DS) are subsequently modulated in a first frequency range (Δf-DS) and second transmission packets provided for transmission of data in a second direction of transmission (US) are modulated in a second frequency range (Δf-US). Finally, the binary frames (BR) are inserted in a first or second transmission packet and the first transmission packets are routed to a first transmission unit (UEE1) and the second transmission packets are routed to a second transmission unit (UEE2) for transfer via the low voltage power network (NSN).

Method and apparatus for conversion of a bidirectional S₀ data stream for transmission via a low-voltage power network

The strong development in the telecommunications market in recent years has resulted in the search for previously unused transmission capacities becoming more important, and attempts being made to make use of existing transmission capacities more efficiently. One known data transmission method is the transmission of data via the power supply network, which is frequency referred to in the literature as “Powerline Communication” or by “PLC”, for short. One advantage of using the power supply network as a medium for data transmission is that the network infrastructure already exists. Virtually every building thus has not only access to the power supply network but also to an existing, widely distributed in-house power network.

In Europe, the power supply network is subdivided into various network structures or transmission levels, depending on the type of power transmission. The high-voltage level, with a voltage range from 110 kV to 380 kV, is used for long-distance power transmission. The medium-voltage level with a voltage range from 10 kV to 38 kV is used to pass the electrical power from the high-voltage network to the area of the consumers, and is reduced by means of suitable network transformers to a low-voltage level, with a voltage range up to 0.4 kV, for the consumers. The low-voltage level is in turn subdivided into a so-called outdoor area—also referred to as the “last mile” or “access area”—and into a so-called in-house area—also referred to as the “last meter”. The outdoor area of the low-voltage level defines the region of the power supply network between the mains transformer and a meter unit which is associated with each consumer. The in-house area of the low-voltage level defines the area from the meter unit to the access units for the consumer.

In Europe, the Standard EN 50065 defines four different frequency bands—frequently referred to as CENELEC Bands A to D in the literature—with a permissible frequency range from 9 kHz to 148.5 kHz, and each having a maximum permissible transmission power, for data transmission via the power supply network, with these frequencies being reserved solely for data transmission on the basis of power line communication. However, data transmission rates of only a few tens of kilobits per second can be achieved in this case due to the restricted transmission power and the narrow bandwidth which is available in this frequency range.

However, data transmission rates in the region of several megabits per second are generally required for telecommunications applications, such as the transmission of speech data. A sufficiently wide transmission bandwidth is required, above all, to provide such a data transmission rate, and this is dependent on a frequency spectrum of up to 20 MHz, with a suitable transmission response. At the moment, data transmission in the frequency range up to 20 MHz with a suitable transmission response can be achieved solely in the low-voltage level of the power supply network.

The transmission of digital speech data additionally results in stringent bandwidth requirements with respect to the real time capability and the maximum permissible bit error rate—BER for short—in the data transmission system. In addition, the transmission of digital speech data is dependent on collision-free point-to-multipoint data transmission using a full duplex mode, that is to say error-free, simultaneous data transmission in both transmission directions between a number of subscribers. One known data transmission method for transmission of digital speech data is the ISDN transmission method (Integrated Services Digital Network). Data transmission in accordance with the ISDN transmission method, which satisfies the abovementioned conditions, may be carried out, for example, on the basis of the known S₀ interface—which is frequently also referred to as a basic access in the literature.

The present invention is based on the object of providing measures by means of which an S₀ interface can be converted for data transmission on the basis of power line communication.

According to the invention, this object is achieved by the features of patent claims 1 and 14.

One major advantage of the method according to the invention and of the apparatus according to the invention, respectively, is that conversion of the known S₀ interface for data transmission on the basis of power line communication allows conventional ISDN communications terminals to be used in a simple and cost-effective manner for data transmission via a low-voltage power network.

Advantageous developments of the invention are specified in the dependent claims.

One advantage of the refinements of the invention which are defined in the dependent claims is, inter alia, that the use of known compression methods and compression devices, for example based on the speech coding algorithm G.729 as standardized by the ITU-T, allows the bandwidth required for transmission of an S₀ data stream via the low-voltage power network to be reduced in a simple manner.

A further advantage of refinements of the invention which are defined in the dependent claims is that the existing tree structure of the low-voltage power a network in the in-house area can easily be mapped onto a master-slave communication relationship between a meter unit, which is configured as a master device and is in each case associated with one consumer, and the communication devices which are connected to the low-voltage power network and are configured as slave devices.

A further advantage of refinements of the invention which are defined in the dependent claims is that the use of the transmission mechanisms implemented for the S₀ interface allows bidirectional and collision-free data transmission via the low-voltage power network, with a maximum of up to eight connected slave devices, without any additional implementation complexity.

One exemplary embodiment of the invention will be explained in more detail in the following text with reference to the drawing, in which:

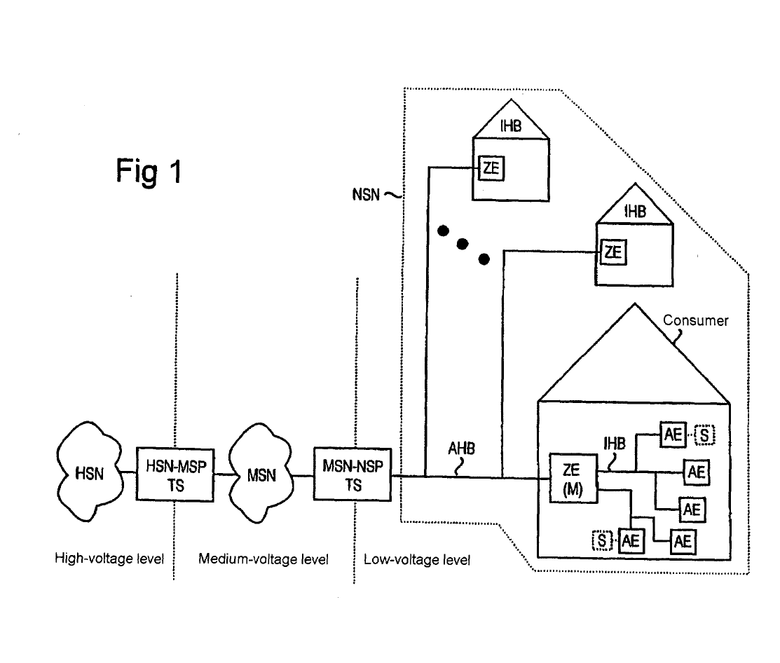

FIG. 1 shows a structogram for schematic illustration of a power supply network;

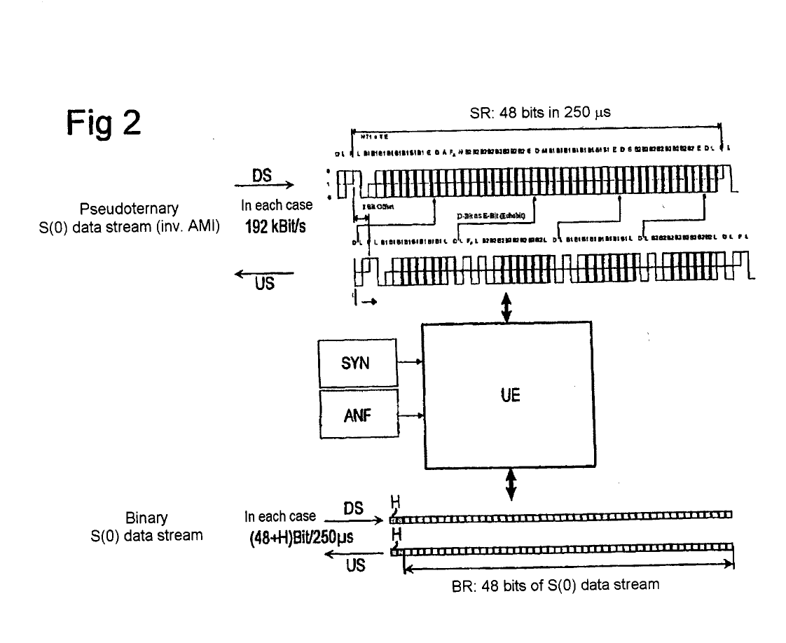

FIG. 2 shows a structogram for schematic illustration of the conversion of an S₀ data stream, which is coded using an inverted AMI channel code, to a binary-coded S₀ data stream;

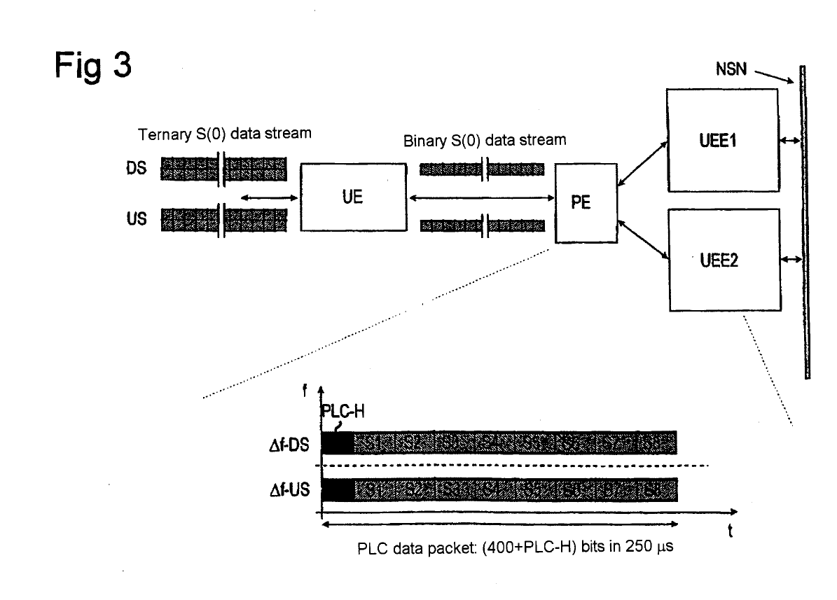

FIG. 3 shows a structogram for schematic illustration of the conversion of the S₀ data stream for transmission via a low-voltage network, according to a first embodiment,

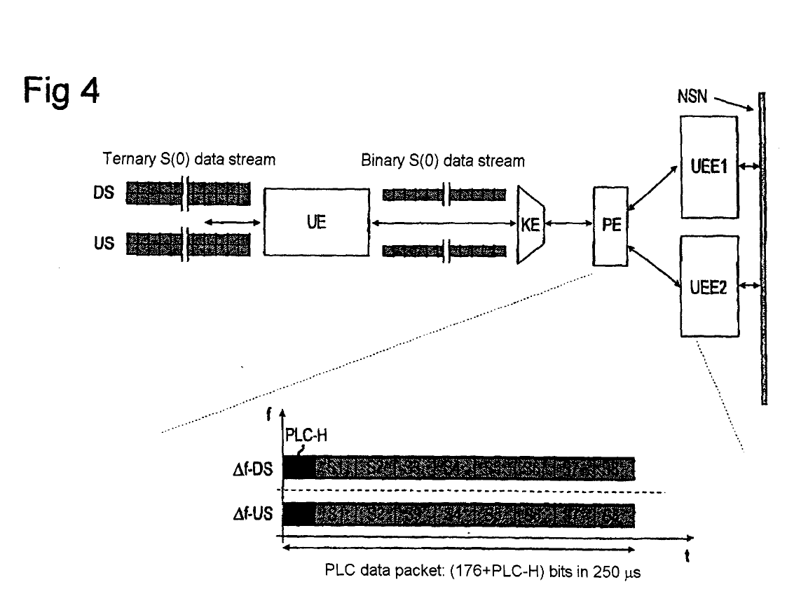

FIG. 4 shows a structogram for schematic illustration of the conversion of the S₀ data stream for transmission via a low-voltage network, according to a second embodiment,

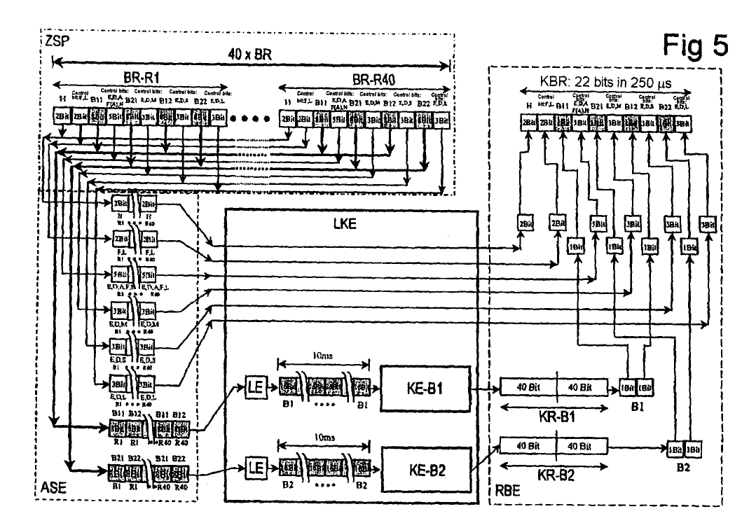

FIG. 5 shows a structogram for schematic illustration of the compression of the binary-coded S₀ data stream carried out by a compression unit;

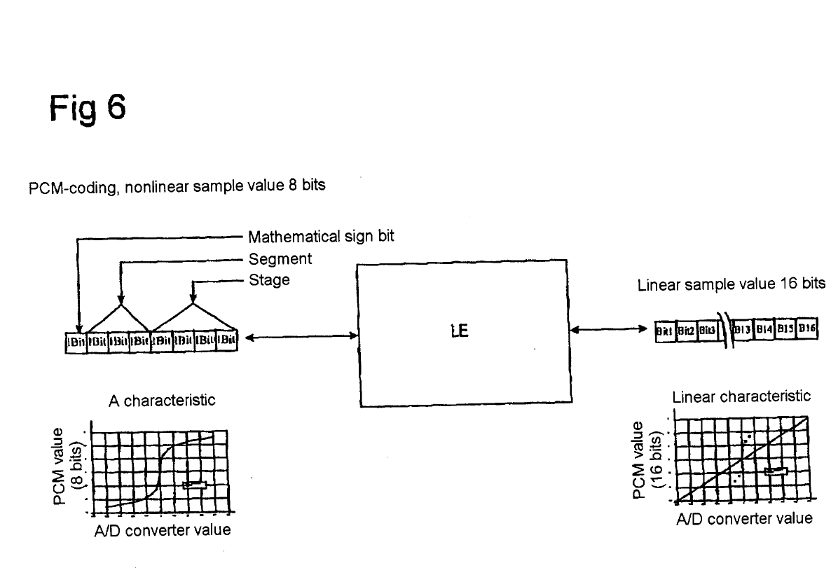

FIG. 6 shows a structogram for schematic illustration of the linearization of the binary-coded S₀ data stream.

FIG. 1 shows a structogram—with a schematic illustration of a power supply network. The power supply network is subdivided into various network structures and/or transmission levels, depending on the type of power transmission. The high-voltage level or the high-voltage network HSN with a voltage range from 110 kV to 380 kV is used to transmit power over long distances. The medium-voltage level or the medium-voltage network MSN with a voltage range from 10 kV to 38 kV is used to carry the electrical power from the high-voltage network to the vicinity of the consumers. The medium-voltage network MSN is in this case connected to the high-voltage network HSN via a transformer station HSN-MSN TS, which converts the respective voltages. The medium-voltage network MSN is also connected via a further transformer station MSN-NSN TS to the low-voltage network NSN.

The low-voltage level or the low-voltage network with a voltage range up to 0.4 kV is subdivided into a so-called outdoor area AHB and into a so-called in-house area IHB. The outdoor area AHB defines the area of the low-voltage network NSN between the further transformer station MSN-NSN TS and a meter unit ZE associated with each respective consumer. The outdoor area AHB connects a number of in-house areas IHB to the further transformer station MSN-NSN TS, which provides the conversion to the medium-voltage network MSN. The in-house area IHB defines the area from the meter unit ZE to access units AE which are arranged in the in-house area IHB. An access unit AE is, for example, a plug socket connected to the low-voltage network NSN. The low-voltage network NSN in the in-house area IHB is in this case generally designed in the form of a tree network structure, with the meter unit ZE forming the root of the tree network structure.

A transmission bandwidth of several megabits per second with a suitable transmission response is required for the transmission of digital speech data—in particular based on the S₀ interface—via the power supply network, and at the moment this can be achieved only in the low-voltage network NSN. The S₀ interface uses a standard line code in the form of a so-called “inverted AMI channel” (Alternate Mark Inversion), which must be converted to a binary code for conversion of the S₀ interface for data transmission via the low-voltage network NSN.

FIG. 2 shows a structogram to schematically illustrate the conversion of an S₀ data stream, which is coded using the inverted AMI channel code, to a binary-coded S₀ data stream. An S₀ data stream in this case comprises a sequence of so-called S₀ frames SR, which can be transmitted successively. The AMI channel code is a pseudoternary line code, in which the two binary states “0” and “1” are represented by the three signal potentials ‘0’, ‘1’ and ‘−1’. In this case, in the inverted AMI channel code, the binary state “1” is represented by the signal potential ‘0’. The binary state “0” is associated either a positive or a negative signal potential ‘1’ or ‘−1’, with the polarity changing between two successive “0” states.

An S₀ interface essentially comprises two payload data channels, which are each in the form of ISDN-oriented B channels with a transmission bit rate of 64 kilobits per second each, and a signaling channel, which is in the form of an ISDN-oriented D channel with a transmission bit rate of 16 kilobits per second. Four-wire transmission is generally provided for bidirectional data transmission via the S₀ interface, with the two transmission directions—referred to as the downstream direction DS and the upstream direction US in the following text—being passed via separate lines. The downstream direction DS in this case defines the data transmission via a transmission path from a central device—referred to as the “master” M in the following text—which controls the transmission, to further devices—referred to as “slaves” S in the following text—which are connected to the transmission path. The upstream direction US defines the data transmission from the respective slaves S to the master M. In the present exemplary embodiment, the associated meter unit ZE in an in-house area IHB is configured as the master M—indicated by the M in brackets in FIG. 1—and communication devices which are connected via the access units AE to the low-voltage network NSN in the in-house area IHB are configured as slaves S. The master M can address a maximum of up to eight different slaves S via the S₀ interface.

The figure in each case shows an S₀ frame SR in the downstream direction DS and in the upstream direction US for a pseudoternary S₀ data stream which is coded using the inverted AMI channel code. An S₀ frame SR has a frame length of 250 μs, and comprises a total of 48 bits. 16 bits of payload information are transmitted via a first payload data channel B1, and 16 bits of payload information are transmitted via a second payload data channel B2, with 4 bits of signaling information being transmitted via the signaling channel, in the course of each S₀ frame SR. Furthermore, additional control bits are transmitted in an S₀ frame SR, for example for access control, for synchronization of the downstream data stream DS and of the upstream data stream US, and in order to provide higher-level system services in accordance with the OSI layer model. This therefore results in a transmission bit rate of 192 kilobits per second in each case, both for the downstream data stream DS and for the upstream data stream US. The conditions for data transmission via the S₀ interface are standardized in the ITU-T (International Telecommunication Union) Specification I.430 “ISDN User Network Interfaces”.

The pseudoternary S₀ data stream which is coded using the inverted AMI channel code is converted by a conversion unit UE to a binary S₀ data stream. In this case, the information, which comprises 48 bits coded using the AMI channel code, in the S₀ frame SR is converted for the downstream data stream DS and for the upstream data stream US to binary-coded information which comprises 48 bits, and is combined by means of a header H with a length of 2 bits to form a binary frame BR with a length of 50 bits. The header H comprises a synchronization bit SYN and an initial state bit ANF. The initial state bit ANF includes information about the signal potential which is associated with the first “0” state in the AMI channel code. Since the signal potential for the “0” state may have the potential 1 or −1, this information is necessary to allow the original AMI channel code to be reproduced at the receiver end. The synchronization bit SYN is used for synchronization of the mutually associated S₀ frames SR which are reproduced from the binary frames BR at the receiver end, for the downstream data stream DS and for the upstream data stream US, since the mutually associated S₀ frames SR for the downstream data stream DS and for the upstream data stream US are offset by two bits with respect to one another—as can be seen from the figure.

This thus in each case results in a transmission bit rate of

(48+2) bits/250 μs=200 kbit/s

for the binary S₀ data stream both for the downstream data stream DS and for the upstream data stream US.

FIG. 3 shows a structogram to schematically illustrate the conversion of the pseudoternary S₀ data stream, which is coded using the inverted AMI channel code, for transmission via the low-voltage network NSN according to a first embodiment. In a first step, the pseudoternary S₀ data stream, which is coded using the inverted AMI channel code, is converted by the conversion unit UE—as described with reference to FIG. 2—to a binary-coded S₀ data stream. The binary-coded S₀ data stream which comprises a sequence of binary frames BR is then passed to a protocol unit PE for conversion to a data format which is intended for data transmission via the low-voltage network NSN.

A master-slave communication relationship is set up on the basis of the tree structure which exists in the in-house area IHB of the low-voltage network NSN, for data transmission between the devices which are connected to the low-voltage network NSN in the in-house area IHB and the meter unit ZE which is associated with the in-house area IHB. In this case, the meter unit ZE which is arranged in the in-house area IHB and forms the root of the tree structure is defined as the master M, and the further devices which are connected via the access units AE to the low-voltage network NSN are defined as slaves S.

So-called PLC data packets with a length of 250 μs each are provided for data transmission via the low-voltage network NSN, and are subdivided into a PLC header PLC-H and a payload data area. The PLC header PLC-H essentially comprises address information for addressing the slaves S which are connected to the low-voltage network NSN. The address information may in this case be formed by an MAC address (Medium Access Control), which is in each case uniquely associated with each of the slaves S. The MAC address is a unique hardware address, which resides in layer 2 of the OSI reference model and has a length of 6 bytes. Alternatively, the slaves S which are connected to the low-voltage network NSN may be addressed by means of VPI/VCI addressing (Virtual Path Identifier/Virtual Channel Identifier), which is based on the ATM protocol (Asynchronous Transfer Mode).

Different PLC data packets are defined for the downstream data stream DS and for the upstream data stream US in order to provide bidirectional data transmission via the low-voltage network NSN, and these are shifted by modulation into two different frequency bands Δf-DS, Δf-US by means of the frequency duplexing method—frequently referred to in the literature as “Frequency Division Duplex”, or “FDD” for short.

In order to ensure collision-free data transmission via the low-voltage network NSN, the payload data areas of the PLC data packets for the downstream area DS-B and for the upstream area US-B are subdivided by means of multiple access control methods based on time division multiplexing—also referred to in the literature as “Time Division Multiple Access” or “TDMA” for short—into a number of channels—frequently also referred to as time slots. The number of channels for each PLC data packet in this case corresponds to the maximum number of slaves S which can be connected to the low-voltage network NSN. As already described, up to a maximum of eight different slaves S1-S8 may be addressed via the S₀ interface by the master M, so that the payload data areas of the PLC data packets in the present exemplary embodiment are each subdivided into eight channels, each having a length of 50 bits. The respective subdivision of the payload data areas of the PLC data packets into the same number of channels is referred to in the literature as symmetrical frame formation.

Each slave S1-S8 is allocated one channel in the payload data area of the respective PLC data packet, on a permanent basis, both for the downstream direction DS and for the upstream direction US. The slave S1-S8 may send and receive data in this channel, that is to say the binary frames BR associated with the slaves S1-S8 are inserted into the respective channel associated with that slave S1-S8, and are removed from it, by the protocol unit PE. The present master-slave communication relationship provides, by way of example, a cyclically fixed, hierarchical transmission sequence for each PLC data packet. This transmission sequence is normally referred to in the literature as “polling”, and can be achieved well by means of the TMDA method.

The PLC data packets are then transmitted from the protocol unit PE to a first transmission unit UEE1 and to a second transmission unit UEE2 for transmission via the low-voltage network NSN. The first and the second transmission units UEE1, UEE2 provide the data transmission, by way of example, based on the OFDM transmission method (Orthogonal Frequency Division Multiplex) with upstream FEC error correction (Forward Error Correction) and upstream DQPSK modulation (Different Quadrature Phase Shift Keying). In this case, by way of example, the first transmission unit UEE1 controls the data transmission via the low-voltage network NSN in a first frequency band Δf-DS, and the second transmission unit UEE2 controls the data transmission in a second frequency band Δf-US. More detailed information relating to these transmission and modulation methods can be found in the diploma thesis, which has not yet been published, by Jörg Stolle: “Powerline Communication PLC”, 5/99, Siemens AG.

In this first conversion mode, the payload data area of the PLC data packet is subdivided into a total of eight channels, each with a length of 50 bits. This means that a transmission bit rate of:

(8×50 bit)/250 μs=1600 kbit/s

is in each case required for the downstream direction DS and for the upstream direction US—ignoring the PLC header.

In contrast to symmetrical frame formation, asymmetric frame formation (not shown) may be implemented as an alternative. In this case, analogously to symmetrical frame formation, different PLC data packets are defined for the downstream data stream DS and for the upstream data stream US in order to provide bidirectional data transmission via the low-voltage network NSN, and are shifted by modulation into two different frequency bands Δf-DS, Δf-US, by means of the frequency duplexing method.

Furthermore, in order to ensure collision-free data transmission, the payload data area of the PLC data packet for the upstream data stream US is subdivided into eight channels, each with a length of 50 bits, by means of the multiple access control method, which is based on time division multiplexing. Each slave S1-S8 is in this case permanently allocated one channel in which it may transmit, that is to say the binary frames BR associated with the slaves S1-S8 are inserted by the protocol unit PE into the respective channel, associated with that slave S1-S8, on the PLC data packet for the upstream data stream US. With the present master-slave communication relationship, the transmission sequence is likewise implemented using “polling”.

The payload data area of the PLC data packet for the downstream data stream DS in the case of asynchronous frame formation comprises only a single channel, with a length of 50 bits, via which data is transmitted from the master M to the slaves S1-S8. Since the master M is the only device which transmits in the downstream direction DS, there is no need for the point-to-multipoint structure which is provided for symmetrical frame formation. With asynchronous frame formation, the payload information to be transmitted by the master M is transmitted in parallel to all the slaves S1-S8. This transmission method is generally referred to as the “broadcasting mode”. This makes it possible to reduce the transmission bit rate required for data transmission via the low-voltage network NSN in the downstream direction DS.

Analogously to symmetrical frame formation, the PLC data packets are then transmitted from the protocol unit PE to the first and second transmission units UEE1, UEE2, for transmission via the low-voltage network NSN.

This means that—ignoring the PLC header—asymmetric frame formation results in a required transmission bit rate of 200 kilobits per second for the downstream direction DS and a required transmission rate of 1600 kilobits per second for the upstream direction US.

In order to reduce the bandwidth required for data transmission via the low-voltage network NSN, the information transmitted in the course of a binary frame BR is compressed, according to a further embodiment of the present invention.

FIG. 4 shows a structogram to schematically illustrate the conversion of the pseudoternary S₀ data stream, which is coded using the inverted AMI channel code, for transmission via the low-voltage network NSN according to the further embodiment of the present invention. In this case, a compression unit KE is connected downstream from the conversion unit UE and upstream of the protocol unit PE and is used to convert the binary frames BR to compressed binary frames KBR. The conversion unit UE, the protocol unit PE and the transmission units UEE1, UEE2 operate as already described with reference to the first embodiment.

The following text describes in more detail the process of compressing the information transmitted in the binary frames BR, as carried out by the compression unit KE. In the present embodiment of the invention, only the payload data information which is transmitted in the course of the payload data channels B1, B2 is compressed. The signaling information, which is transmitted in the course of the signaling channel D, and the additional control information are transmitted in a transparent form, that is to say without compression.

FIG. 5 shows a schematic illustration of a method for compression of the binary-coded S₀ data stream, which comprises a sequence of binary frames BR. In this case, forty binary frames BR-R1, . . . , BR-R40 which are associated with one transmission direction DS, US are in each case buffer-stored in a memory device ZSP in the compression unit KE. If the binary frames BR each have a duration of 250 μs, this corresponds to a total duration of 10 ms. The buffer-stored binary frames BR-R1, . . . , BR-R40 are then each subdivided into logical units, and are separated from one another, in a separation unit ASE. Logical units are formed, by way of example, by the header H, the first payload data channel B1 and the second payload data channel B2. The signaling channel D and the additional control bits of the binary frames BR-R1, . . . , BR-R40 form further logical units, depending on their position in the binary frame BR. The logical units in the binary frames BR-R1, . . . , BR-R40 are then as illustrated in the figure—combined to form in each case one processing frame, and are passed to a linearization and compression unit LKE. The processing frames, which are formed from the header H, the signaling channel D and the additional control bits, are in this case passed in a transparent form, that is to say without compression, through the linearization and compression unit LKE.

The processing frames which are associated with the first and the second payload data channels B1, B2 are, in contrast, each supplied to a linearization unit LE in the linearization and compression unit LKE. The processing frame which is associated with one payload data channel B1, B2 comprises a total of eighty payload data bytes which are associated with a respective payload data channel B1, B2, with each binary frame BR-R1, . . . , BR-R40 in each case having two associated payload data bytes in the processing frame. The payload data information transmitted in the course of the first and second payload data channels B1, B2 is coded, as standard, according to a nonlinear, so-called A characteristic with a resolution of 8 bits. In order to allow known compression methods to be used, the payload data information must be linearized before the compression process. At the same time as the linearization process, a conversion is carried out from 8-bit resolution to 16-bit resolution. For each of the first and second payload data channels B1, B2, this results in a processing frame with a length of 80×16=1280 bits, and a duration of 10 Ms.

The processing frames, with the linear-coded payload data information, are then supplied to a respective channel-specific compression unit KE-B1, KE-B2. The channel-specific compression units KE-B1, KE-B2 carry out a compression process on the payload data information transmitted in the processing frames, in accordance with the compression method G.729, as standardized by the ITU-T. This speech coding algorithm converts the linear-coded 16-bit sample values at a sampling frequency of 8 kHz to an 8 kilobit per second data stream. A speech segment with a duration of 10 ms—in the present example this corresponds to a length of 1280 bits of payload data information—is required for this purpose, for parameter calculation to be carried out in accordance with the algorithm. At the output of the channel-specific compression units KE-B1, KE-B2, this thus results for the first and second payload data channels B1, B2 in respective compressed processing frames KR-B1, KR-B2 with 80 bits of compressed payload data information and a duration of 10 ms. As an alternative to the compression method G.729 as standardized by the ITU-T, other compression methods may also be used for compression.

The compressed processing frames KR-B1, KR-B2 are then supplied to a frame formation unit RBE, which separates the compressed payload data information contained in the compressed processing frames KR-B1, KR-B2 in accordance with the originally uncompressed binary frames BR-R1, . . . , BR-R40 and joins these frames to the further information—as illustrated in the figure which is passed in transparent form through the linearization and compression unit LKE, to form a compressed binary frame KBR. A compressed binary frame KBR thus has 22 bits of information—4 bits of payload data information and 18 bits of additional information—with a duration of 250 μs. The transmission bandwidth which is required for transmission of a compressed binary frame KBR is thus reduced from 200 kilobits per second to 88 kilobits per second, in contrast to an uncompressed binary frame BR. The compressed binary frames KBR are then, in a manner analogous to the first embodiment, transmitted to the first or to the second transmission unit UEE1, UEE2 for feeding into the low-voltage network NSN.

This thus results in a transmission bit rate of 704 kilobits per second being required in each case, both for the downstream direction DS and for the upstream direction, with symmetrical frame formation ignoring the PLC header.

A transmission bit rate of 88 kilobits per second is required for the downstream direction DS, and a transmission rate of 704 kilobits per second is required for the upstream direction US with asymmetric frame formation—ignoring the PLC header.

FIG. 6 now shows a schematic illustration of a method for linearization of the payload data information which is combined in the processing frames. The payload data information which is transmitted in the payload data channels B1, B2 is coded on the basis of the pulse code modulation, or PCM for short. The pulse code modulation uses a nonlinear, so-called “A characteristic” for coding.

The A characteristic is composed of a total of 13 segments. According to the ITU-T definition, each amplitude of a signal to be sampled is represented by 8 bits. The first bit indicates the mathematical sign of the sampled signal. The next 3 bits define the relevant segment of the A characteristic, and the last 4 bits define a quantization step within one segment. There are thus 256 quantization steps, overall.

The linearization unit LE converts the payload information, which has been coded on the basis of the nonlinear A characteristic, to a signal which is coded on the basis of a linear characteristic. At the same time, the 8-bit resolution used by the A characteristic is converted to 16-bit resolution. The use of linear coding with 16-bit resolution satisfies the preconditions for subsequent use of the compression method in accordance with the ITU-T Standard G.729.

At the receiver end, the PLC data packets are read from the low-voltage network NSN and are converted to a pseudoternary S₀ data stream, which is coded using the inverted AMI channel code, analogously to the described method of operation, but in the opposite direction.

1. A method for conversion of an S₀ data stream for transmission via a low-voltage power network (NSN),
in which the pseudoternary S₀ data stream, comprising a sequence of S₀ frames (SR), is converted to a binary data stream comprising a sequence of binary frames (BR), in which method first transmission packets, which are intended for data transmission in a first transmission direction (DS) are modulated by means of a frequency duplexing method (frequency division duplex FDD) into a first frequency band (Δf-DS), and second transmission packets, which are intended for data transmission in a second transmission direction (US), are modulated into a second frequency band (Δf-US), and
in which method the binary frames (BR) are inserted, depending on the direction, into the first or the second transmission packets, and the first transmission packets are passed to a first transmission unit (UEE1), and the second transmission packets are passed to a second transmission unit (UEE2), for feeding into the low-voltage power network (NSN).

2. The method as claimed in claim 1,
characterized
in that a master-slave communication relationship is set up for data transmission via the low-voltage power network (NSN).

3. The method as claimed in claim 1 or 2,
characterized
in that binary frames (BR) are transmitted in the first transmission packets from a master device (M) to at least one slave device (S1-S8), and binary frames (BR) are transmitted in the second transmission packets from the at least one slave device (S1-S8) to the master device (M).

4. The method as claimed in claim 3,
characterized
in that the master device (M) allocates transmission and reception rights for the slave devices (S1-S8) using a polling method.

5. The method as claimed in one of the preceding claims,
characterized
in that the transmission packets are each subdivided into at least one subframe by means of a multiple access control method based on time division multiplexing (time division multiple access TDMA), and
in that the binary frames (BR) are inserted into a subframe in the first transmission packet or in the second transmission packet depending on the direction.

6. The method as claimed in claim 5,
characterized
in that the first and the second transmission packets are each subdivided into eight subframes, with each slave device (S1-S8) which is connected to the low-voltage power network (NSN) in each case being assigned one subframe in the first transmission packets and one subframe in the second transmission packets, on a permanent basis, for bidirectional data transmission with the master device (M).

7. The method as claimed in claim 5,
characterized
in that the first transmission packets are subdivided into an individual subframe, and the second transmission packets are subdivided into eight subframes, with each slave device (S1-S8) which is connected to the low-voltage power network (NSN) in each case being assigned one subframe in the second transmission packets, on a permanent basis, for data transmission to the master device (M), and data being transmitted from the master device (M) to the slave devices (S1-S8) jointly via the subframes of the first transmission packets.

8. The method as claimed in one of the preceding claims,
characterized
in that, during conversion of an S₀ frame (SR) to a binary frame (BR), information is inserted for recovery of the S₀ frame (SR).

9. The method as claimed in claim 8,
characterized
in that an initial state bit (ANF) and a synchronization bit (SYN) are inserted as information into the binary frame (BR).

10. The method as claimed in one of the preceding claims,
characterized
in that payload information which is contained in a binary frame (BR) is separated from the binary frame (BR) and is then compressed,
in that the compressed payload information is combined with the uncompressed information in the binary frame (BR) to form a compressed binary frame (KBR), and
in that the compressed binary frames (KBR) are inserted into the first or the second transmission packets, depending on the direction.

11. The method as claimed in claim 10,
characterized
in that the payload information is compressed in accordance with the compression method G.729 standardized by the ITU-T.

12. The method as claimed in claim 11,
characterized
in that the payload information which is allocated to a first payload data channel (B1) and the payload information which is allocated to the second payload data channel (B2) are compressed separately in in each case one channel-specific compression device (KE-B1, KE-B2).

13. The method as claimed in one of claims 10 to 12,
characterized
in that the payload information which is coded in accordance with a nonlinear A-characteristic and has 8-bit resolution is converted, before being compressed, to a linear signal which has 16-bit resolution.

14. An apparatus for conversion of an S₀ data stream for transmission via a low-voltage power network (NSN),
having a conversion unit (UE) for conversion of the pseudoternary S₀ data stream, which comprises a sequence of S₀ frames (SR) to a binary data stream which comprises a sequence of binary frames (BR), having a protocol unit (PE) for insertion of the binary frames (BR) into transmission packets which are intended for data transmission via the low-voltage power network (NSN) with first transmission packets, which are intended for data transmission in a first transmission direction (DS), being modulated by means of a frequency duplexing method (frequency division duplex FDD) into a first frequency band (Δf-DS), and second transmission packets, which are intended for data transmission in a second transmission direction (US), being modulated into a second frequency band (Δf-US),
having a first transmission unit (UEE1) for feeding the first transmission packets into the low-voltage power network (NSN), and having a second transmission unit (UEE2) for feeding the second transmission packets into the low-voltage power network (NSN).

15. The apparatus as claimed in claim 14,
characterized
by a compression unit (KE) which is connected upstream of the protocol unit (PE), having
a separation unit (ASE) for separation of payload information contained in a binary frame (BR),
a linearization and compression unit (LKE) for compression of the separated payload information, and
a frame forming unit for combination of the compressed payload information with the uncompressed information in the binary frame (BR) to form a compressed binary frame (KBR).

16. The apparatus as claimed in claim 15,
characterized
in that the compression unit (KE) is designed in accordance with the compression method G.729 which has been standardized by the ITU-T.

17. The apparatus as claimed in claim 15 or 16,
characterized
in that the linearization and compression unit (LKE) has two channel-specific compression units (KE-B1, KE-B2).

18. The apparatus as claimed in claim 17,
characterized
in that a linearization unit (LE) for conversion of the payload information, which is coded in accordance with a nonlinear A-characteristic and has 8-bit resolution, to a linear signal which has 16-bit resolution is connected upstream of each of the channel-specific compression units (KE-B1, KE-B2).

19. The apparatus as claimed in one of claims 14 to 18,
characterized
in that a master-slave communication relationship is set up for data transmission via the low-voltage power network (NSN).

20. The apparatus as claimed in claim 19,
characterized
in that a counter device (ZE), which is associated with an in-house area (IHB) of the low-voltage power network (NSN), is in the form of a master device (M).

21. The apparatus as claimed in claim 19 or 20,
characterized
in that communication devices which are each connected via a connecting device (AE) to the in-house area (IHB) of the low-voltage power network (NSN) are in the form of slave devices (S1-S8).

22. The apparatus as claimed in claim 21,
characterized
in that a maximum of eight slave devices (S1-S8) can be connected to the low-voltage power network (NSN).
